(19) United States
(12) Patent Application Publication
(10) Pub. No.: US 2023/0404152 A1
(43) Pub. Date: Dec. 21, 2023

(54) A Vapour Generating System

(71) Applicant: JT International SA, Geneva (CH)

(72) Inventors: Dick Paul Voerman, Apeldoorn (NL); Ernst Hupkes, Kampen (NL); Dennis Freie, Zwolle (NL)

(73) Assignee: JT International SA, Geneva (CH)

(21) Appl. No.: 18/031,427

(22) PCT Filed: Oct. 15, 2021
(86) PCT No.: PCT/EP2021/078648

§ 371 Date: Apr. 12, 2023

(30) Foreign Application Priority Data
Oct. 23, 2020 (EP) 20203486.4

(51) Int. Cl. A24F 40/46; A24F 40/10; A24F 40/42; A24F 40/44; A24F 40/70; H05B 3/06

(52) U.S. Cl. CPC A24F 40/46; A24F 40/10; A24F 40/42; H05B 2203/021; A24F 40/70; H05B 3/06; A24F 40/44

(57) ABSTRACT

A vapour generating system includes a base part including at least one heating element and a cartridge releasably connectable to the base part. The cartridge includes: a liquid store for storing a vapour generating liquid, the liquid store including a liquid outlet; a vaporization chamber in communication with the liquid outlet for receiving vapour generating liquid from the liquid store; and a heat transfer unit configured to transfer heat from the heating element to the vaporization chamber to vaporize vapour generating liquid in the vaporization chamber. The heat transfer unit includes a pliable heat transfer surface in contact with the heating element of the base part.

### TECHNICAL FIELD

The present disclosure relates generally to a vapour generating system configured to heat a vapour generating liquid to generate a vapour which cools and condenses to form an aerosol for inhalation by a user of the system. Embodiments of the present disclosure relate in particular to a vapour generating system comprising a reusable base part and a cartridge configured to be used with reusable base part.

### TECHNICAL BACKGROUND

The term vapour generating system (or more commonly electronic cigarette or e-cigarette) refers to a handheld electronic device that is intended to simulate the feeling or experience of smoking tobacco in a traditional cigarette. Electronic cigarettes work by heating a vapour generating liquid to generate a vapour that cools and condenses to form an aerosol which is then inhaled by the user. Accordingly, using e-cigarettes is also sometimes referred to as “vaping”. The vapour generating liquid usually comprises nicotine, propylene glycol, glycerine and flavourings.

Typical e-cigarette vaporizing units, i.e. systems or sub-systems for vaporizing the vapour generating liquid, utilize a cotton wick and heating element to produce vapour from liquid stored in a capsule or tank. When a user operates the e-cigarette, liquid that has soaked into the wick is heated by the heating element, producing a vapour which cools and condenses to form an aerosol which may then be inhaled. To facilitate the ease of use of e-cigarettes, cartridges are often used. These cartridges are often configured as “cartomizers”, which means an integrated component formed from a liquid store (reservoir), a liquid transfer element (e.g. a wick) and a heater. Electrical connectors may also be provided to establish an electrical connection between the heating element and a power source. Such cartridges may be disposable, i.e. not intended to be capable of reuse after the supply of liquid in the reservoir has been exhausted. Alternatively, they may be reusable, being provided with means allowing the reservoir to be refilled with a new supply of vapour generating liquid. Particularly in the case of disposable cartridges, it is desirable to reduce the number and complexity of their components, thereby reducing waste and making the manufacturing process simpler and cheaper.

It has, therefore, been proposed to provide a vapour generating system in which a heating element is integrated into a reusable base part and in which a disposable cartridge containing vapour generating liquid is releasably connectable to the base part such that the vapour generating liquid can be heated by the heating element in the base part. Integrating the heating element into the reusable base part allows the cartridge structure to be simplified. There is, however, a need to maximise heat transfer from the heating element in the reusable base part to the vapour generating liquid in the cartridge, and the present disclosure seeks to address this need.

### SUMMARY OF THE DISCLOSURE

According to a first aspect of the present disclosure, there is provided a vapour generating system comprising:
a base part including at least one heating element;
a cartridge releasably connectable to the base part, the cartridge comprising:
   a liquid store for storing a vapour generating liquid, the liquid store including a liquid outlet;
   a vaporization chamber in communication with the liquid outlet for receiving vapour generating liquid from the liquid store;
   a heat transfer unit configured to transfer heat from the heating element to the vaporization chamber to vaporize vapour generating liquid in the vaporization chamber;
wherein the heat transfer unit includes a pliable heat transfer surface in contact with the heating element of the base part.

The base part may include a power supply unit, e.g. a battery, connected to the heating element. In operation, upon activating the vapour generating system, the power supply unit electrically heats the heating element of the base part, which then provides its heat by conduction to the heat transfer unit of the cartridge. The heat transfer unit, in turn, provides the heat to the vaporization chamber, resulting in vaporization of the vapour generating liquid. Vapour created during this process is transferred from the vaporization chamber via a vapour outlet channel in the cartridge so that it can be inhaled by a user of the vapour generating system.

The heat transfer from the heating element in the base part to the heat transfer unit in the cartridge is maximized because the pliable heat transfer surface ensures that there is an optimum contact between the heating element and the heat transfer unit. The energy efficiency of the vapour generating system is thereby improved.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The pliable heat transfer surface may be formed by a flexible layer applied to the heat transfer unit. The flexible layer may be applied as a coating. The pliable heat transfer surface is thereby easily formed, thus improving the manufacturability of the heat transfer unit.

The flexible layer may comprise a thermally conductive material. The thermally conductive flexible layer thereby promotes heat transfer from the heating element to the vaporization chamber, thereby improving the energy efficiency of the vapour generating system.

The heat transfer unit may comprise a plurality of first portions lying substantially in a first plane and may comprise a plurality of second portions stepped out of the first plane and lying substantially in a second plane. The second plane may be below the first plane and may be substantially parallel with the first plane. The plurality of second portions may contact the sorption member in contact zones. Heat is transferred from the heat transfer unit to the sorption member in the contact zones primarily by conduction from the second portions of the heat transfer unit to the sorption member. This further improves energy efficiency and reduces the energy consumption of the vapour generating system.

The heat transfer unit may be a substantially circular heat transfer unit. The first portions may be circumferentially spaced around the heat transfer unit and the second portions may be circumferentially spaced around the heat transfer unit. The second portions may be arranged circumferentially between the first portions. The heat transfer unit can be manufactured with relative ease.

The first and second portions may be substantially planar and may have corresponding first and second pliable heat transfer surfaces.

In a first example, the heating element may comprise a substantially planar heating surface in contact with the first pliable heat transfer surfaces. The first portions of the heat transfer unit are heated due to the contact between the first pliable heat transfer surface and the planar heat transfer surface, with the second portions being heated indirectly by heat transferred from the first portions. This arrangement may allow the use of a heating element with a simple geometry.

In a second example, the heating element may comprise a non-planar heating surface which may contact at least the second pliable heat transfer surfaces. Thus, the second portions of the heat transfer unit are heated directly due to the contact between the second pliable heat transfer surfaces and the non-planar heating surface of the heating element. Heating of the first portions, which are not in contact with the sorption member, is thereby minimised which means that heat is transferred more efficiently from the heat transfer unit to the sorption member in the contact zones. This in turn reduces energy consumption. It may also reduce the temperature of the heat transfer unit, and in particular the temperature of the first portions. This in turn reduces heat transfer to other parts of the cartridge and the vapour generating system, thereby further reducing energy consumption and possibly reducing the temperature of an outer surface of the vapour generating system which can improve user comfort.

The vapour generating system may further comprise a sorption member at least partially disposed within the vaporization chamber for absorbing vapour generating liquid from the liquid store via the liquid outlet. The heat transfer unit may contact the sorption member to heat the sorption member and vaporize the absorbed vapour generating liquid. This is a continuous process, in which vapour generating liquid from the liquid store is continuously absorbed by the sorption member. As noted above, vapour created during this process is transferred from the vaporization chamber via a vapour outlet channel in the cartridge so that it can be inhaled by a user of the vapour generating system.

The vapour generating liquid may comprise polyhydric alcohols and mixtures thereof such as glycerine or propylene glycol. The vapour generating liquid may contain nicotine and may, therefore, be designated a nicotine-containing liquid. The vapour generating liquid may contain one or more additives, such as a flavouring.

The sorption member can be made of any material or a combination of materials being able to perform sorption and/or absorption of another material, and can be made, for example, of one or more of the following materials: fibre, glass, aluminium, cotton, ceramic, cellulose, glass fibre wick, stainless steel mesh, polyethylene (PE), polypropylene, polyethylene terephthalate (PET), poly(cyclohexanedimethylene terephthalate) (PCT), polybutylene terephthalate (PBT), polytetrafluoroethylene (PTFE), expanded polytetrafluoroethylene (ePTFE), and BAREX®, etc.

The heat transfer unit may comprise a thermally conductive material, for example, a metal such as aluminium, copper, etc.

The heating element may comprise an electrically resistive material. The heating element may include a ceramic material, for example tungsten and alloys thereof. The use of a ceramic material conveniently helps to rigidify the heating element. The heating element may be at least partially encapsulated in, or coated with, a protective material, such as glass.

The heating element may be formed using a metal having a defined relationship between temperature and resistivity. In such embodiments, the metal may be formed as a track between two layers of suitable insulating materials. A heating element formed in this manner may be used both as a heater and a temperature sensor.

The heating element may include a temperature sensor embedded therein or attached thereto.

The power supply unit, e.g. battery, may be a DC voltage source. For example, the power supply unit may be a Nickel-metal hydride battery, a Nickel cadmium battery, or a Lithium based battery, for example a Lithium-Cobalt, a Lithium-Iron-Phosphate, a Lithium-Ion or a Lithium-Polymer battery.

The base part may further comprise a processor associated with electrical components of the vapour generating system, including the battery.

The cartridge may further comprise: a cartridge housing at least partially including the liquid store and the vaporization chamber, and a vapour outlet channel extending along the cartridge housing and in fluid communication with the vaporization chamber. The cartridge housing may have a proximal end configured as a mouthpiece end which is in fluid communication with the vaporization chamber via the vapour outlet channel and a distal end associated with the heat transfer unit. The mouthpiece end may be configured for providing the vaporized liquid to the user. The heat transfer unit may be disposed at the distal end. The heat transfer unit may be substantially perpendicular to the vapour outlet channel.

The liquid store may be juxtaposed with the vapour outlet channel extending between the vaporization chamber and the mouthpiece end. The liquid store may be disposed around the vapour outlet channel.

The cartridge housing may be made of one or more of the following materials: aluminium, polyether ether ketone (PEEK), polyimides, such as Kapton®, polyethylene terephthalate (PET), polyethylene (PE), high-density polyethylene (HDPE), polypropylene (PP), polystyrene (PS), fluorinated ethylene propylene (FEP), polytetrafluoroethylene (PTFE), polyoxymethylene (POM), polybutylene terephthalate (PBT), Acrylonitrile butadiene styrene (ABS), Polycarbonates (PC), epoxy resins, polyurethane resins and vinyl resins.

According to a second aspect of the present disclosure, there is provided a method for manufacturing the heat transfer unit defined above, the method comprising:
applying a flexible layer to the heat transfer unit to form the pliable heat transfer surface.

According to a third aspect of the present disclosure, there is provided a method for manufacturing the vapour generating system defined above, the method comprising:
applying a flexible layer to the heat transfer unit to form the pliable heat transfer surface.

The step of applying the flexible layer may include applying a coating to the heat transfer unit. As noted above, the flexible layer can be applied in a simple manner, thereby improving the manufacturability of the heat transfer unit.

### BRIEF DESCRIPTION OF THE DRAWINGS

FIG. 1 is a schematic view of a vapour generating system comprising a base part and a cartridge;

FIG. 2 is a perspective view of a first example of a cartridge;

FIG. 3 is a cross-sectional view of the cartridge shown in FIG. 2;

FIGS. 4 and 5 are schematic perspective views respectively from above and below a heat transfer unit of the cartridge; and

FIGS. 6 and 7 are schematic perspective views of exemplary embodiments of a heating element of the base part.

### DETAILED DESCRIPTION OF EMBODIMENTS

Embodiments of the present disclosure will now be described by way of example only and with reference to the accompanying drawings.

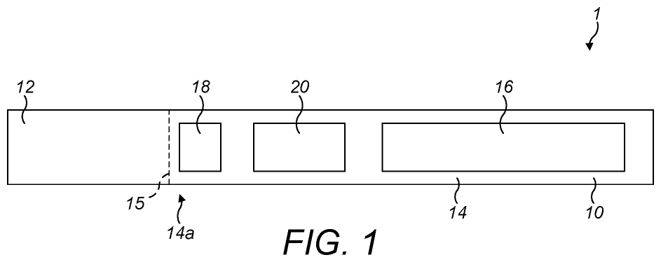

Referring initially to FIG. 1, there is shown schematically a vapour generating system 1 for vaporizing a vapour generating liquid to generate a vapour (or aerosol) for inhalation by a user of the system 1. The vapour generating system 1 comprises a base part 10 and a cartridge 12 thermically connected to the base part 10. The base part 10 is thus the main body part of the vapour generating system 1 and is preferably re-usable.

The base part 12 comprises a housing 14 accommodating a power supply unit in the form of a battery 16 connected to a resistive heating element 18 located at a first end 14a of the housing 14. The first end 14a of the housing 14 has an interface 15 configured for matching a corresponding interface of the cartridge 12. The battery 16 is configured for providing the heating element 18 with the necessary electrical power for its operation, allowing it to become heated to a required temperature. The battery 16 is also connected to a processor 20, enabling the required power supply for its operation. The processor 20 is connected to the heating element 18 and controls its operation.

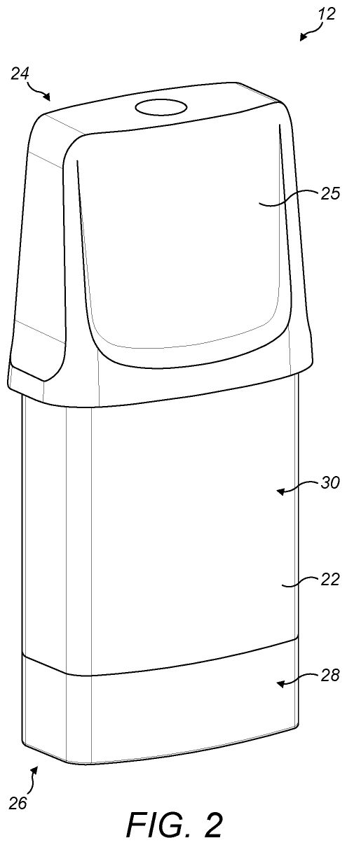

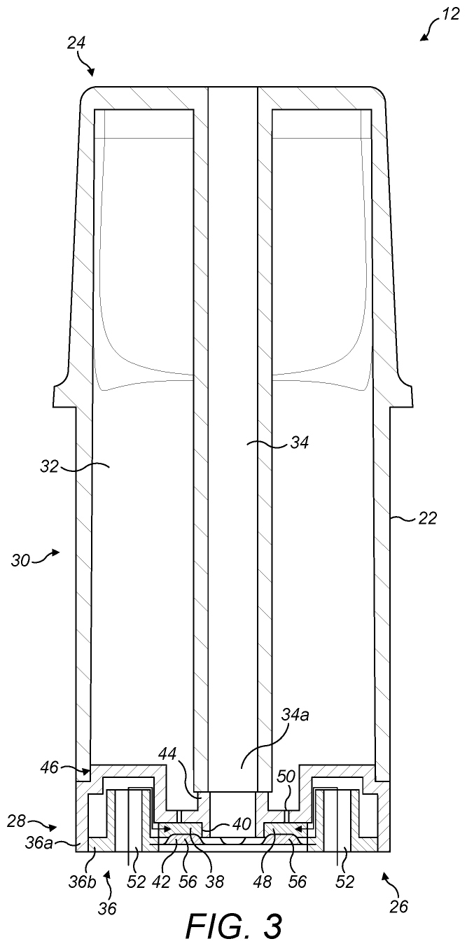

Referring additionally to FIGS. 2 and 3, in a first example the cartridge 12 comprises a cartridge housing 22 having a proximal end 24 and a distal end 26. The proximal end 24 may constitute a mouthpiece end configured for being introduced directly into a user's mouth and may, therefore, also be designated as the mouth end 24. In some embodiments, a mouthpiece 25 may be fitted to the proximal end 24 as shown in FIG. 2.

The cartridge 12 comprises a base portion 28 and a liquid storage portion 30. The liquid storage portion 30 comprises a liquid store 32, configured for containing therein a vapour generating liquid, and a vapour outlet channel 34. The vapour generating liquid may comprise an aerosol-forming substance such as propylene glycol and/or glycerol and may contain other substances such as nicotine and acids. The vapour generating liquid may also comprise flavourings such as, e.g., tobacco, menthol, or fruit flavour. The liquid store 32 may extend generally between the proximal end 24 and the distal end 26, but is spaced from the distal end 26. The liquid store 32 may surround, and coextend with, the vapour outlet channel 34.

As best seen in FIG. 3, the base portion 28 of the cartridge 12 may be configured to sealingly close off the distal end 26 of the cartridge 12. The base portion 28 comprises a plug assembly 36 comprising first and second plug members 36a, 36b, a ring shaped sorption member 38 having a centrally positioned hole 40, and a heat transfer unit 42 which are all positioned at the distal end 26 of the cartridge housing 22, and more particularly in the space formed between the liquid store 32 and the distal end 26. The plug assembly 36, and more specifically the first plug member 36a, closes the distal end 26 of the cartridge housing 22 and thereby retains the vapour generating liquid in the liquid store 32.

The first plug member 36a is provided with a circumferential surface 46 that is in contact with the inner circumferential surface of the liquid store 32. The first plug member 36a may be formed of a material with an elasticity that provides a sealing effect when the circumferential surface 46 contacts the inner circumferential surface of the liquid store 32. For example, the first plug member 36a may comprise rubber or silicone. Alternatively, the first plug member 36a may comprise a thermoplastic material which enables the first plug member 36a and the liquid store 32 to be joined together by, e.g., ultrasonic welding. The first plug member 36a comprises a connecting portion 44 which is configured to sealingly connect to a distal end 34a of the vapour outlet channel 34 as shown in FIG. 3.

The cartridge 12 includes a vaporization chamber 48 defined between the first plug member 36a and the heat transfer unit 42. The sorption member 38 is positioned in the vaporization chamber 48. The first plug member 36a includes a plurality of circumferentially spaced liquid outlets 50 which provide a controlled flow of vapour generating liquid from the liquid store 32 to the sorption member 38 positioned in the vaporization chamber 48 adjacent to the liquid outlets 50.

The sorption member 38 is positioned in the vaporization chamber 48 between the liquid outlets 50 and the heat transfer unit 42. The sorption member 38 is configured, on the one hand, for absorbing therein some of the vapour generating liquid from the liquid store 32, and, on the other hand, for being heated by the heat transfer unit 42 thereby allowing the vapour generating liquid absorbed therein to be vaporized in the vaporization chamber 48.

When the base part 10 and the cartridge 12 are assembled together as shown schematically in FIG. 1, the heating element 18 of the base part 10 contacts the heat transfer unit 42 of the cartridge 12, such that the cartridge 12 is thermically connected to the base part 10. In operation, the heating element 18 is resistively heated by the power from the battery 16 and provides its heat to the heat transfer unit 42 via conduction. The heat from the heat transfer unit 42 is then transferred to the sorption member 38, mainly by conduction. Thus, the sorption member 38 is heated indirectly by the heat transfer unit 42, and not directly by the heating element 18 of the base part 10. The heating element 18 in the base part 12 ideally needs to attain a temperature of around 500° C. in order to transfer enough heat such that the interface between the sorption member 38 and the heat transfer unit 42 reaches a temperature at which vaporization occurs (typically between 200° C. and 250° C.). As a result of heating of the sorption member 38, the vapour generating liquid absorbed therein from the liquid store 32 is vaporized in the vaporization chamber 48, and the vapour escapes from the vaporization chamber 48 via the vapour outlet channel 34 when a user sucks on the proximal (mouth) end 24 of the cartridge 12. The vapour cools and condenses as it flows through the vapour outlet channel 34 to form an aerosol that can be inhaled by a user via the proximal (mouth) end 24.

The cartridge 12 includes air inlets 52 to allow air to flow to the vaporization chamber 48 during use of the vapour generating system 1 when a user sucks on the proximal (mouth) end 24 of the cartridge 12 as described above. In the illustrated example, the air inlets 52 are formed in the second plug member 36b and allow air to flow to the vaporization chamber 48 along a path formed between the first and second plug members 36a, 36b as shown in FIG. 3. Other configurations are, however, entirely within the scope of the present disclosure.

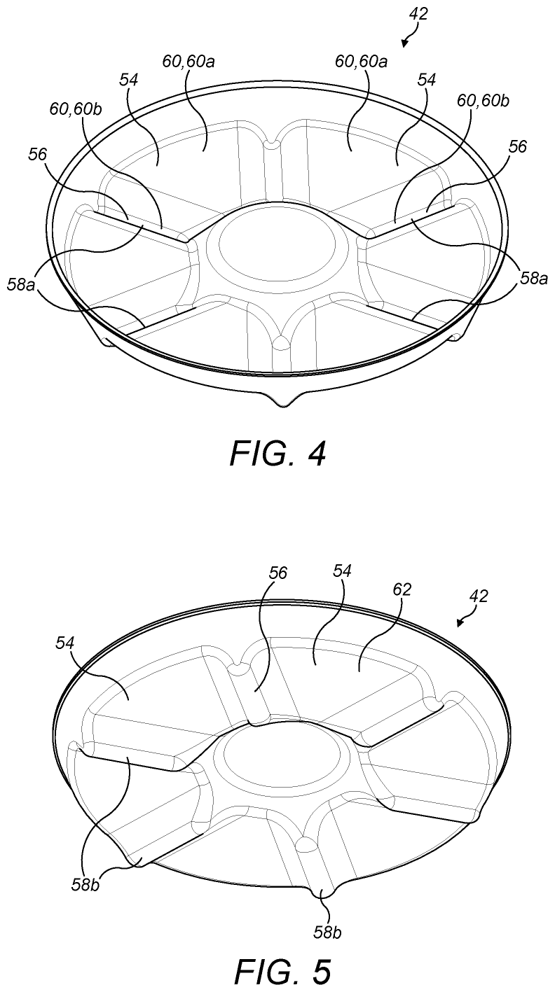

Referring additionally to FIGS. 4 and 5, the heat transfer unit 42 is substantially circular or disc shaped and includes a plurality of first portions 54 lying substantially in a first plane and a plurality of second portions 56 which lie below the first portions 54 in a second plane that is substantially parallel with the first plane. The first and second portions 54, 56 are alternately and circumferentially spaced around the heat transfer unit 42, that is the second portions 56 are arranged circumferentially between the first portions 54. The first portions 54 are spaced from the sorption member 38 whereas the second portions 56 contact the sorption member 38 (see FIG. 3) such that the sorption member 36 and the heat transfer unit 40 are only in partial contact. The heat transfer unit 42 can thus be seen as being provided with ridges 58b (see FIG. 5) on the side in contact with the sorption member 38 and with grooves 58a (see FIG. 4) on the side facing the heating element 20.

The heat transfer unit 42 includes a pliable heat transfer surface 60 which contacts the heating element 18 when the base part 10 and the cartridge 12 are assembled together. In the illustrated embodiment, each of the first portions 54 has a first pliable heat transfer surface 60a and each of the second portions 56 has a second pliable heat transfer surface 60b. As will be apparent from FIG. 4, the first and second pliable heat transfer surfaces 60a, 60b are provided on an upper side of the heat transfer unit 42 which is contacted by the heating element 18 of the base part 10.

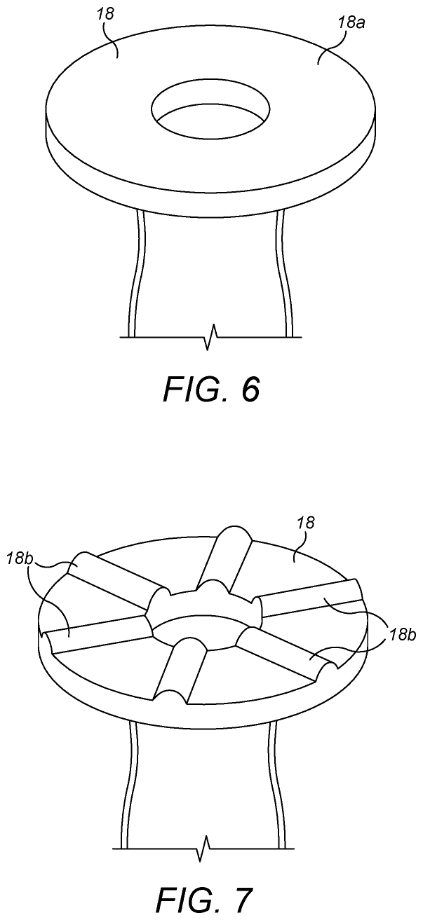

In one embodiment shown in FIG. 6, the heating element 18 of the base part 10 may comprise a substantially planar heat transfer surface 18a and may, for example, comprise a circular or disc shaped heating element 18 which only contacts the upper surfaces of the first portions 54. In this case, it may be necessary for only the first portions 54 to have corresponding first pliable heat transfer surfaces 60a. In another embodiment shown in FIG. 7, the heating element 18 may comprise a plurality of protruding heat transfer surfaces 18b, which may have a shape and form which can enter into the grooves 58a of the heat transfer unit 42. In this case, it may be preferable for both the first portions 54 and the second portions 56 to have corresponding first and second pliable heat transfer surfaces 60a, 60b as described above to optimise the contact between the non-planar heating surface of the heating element 18 and the heat transfer unit 42.

The pliable heat transfer surface 60 may comprise a flexible layer applied to the upper surface of the heat transfer unit 42. The flexible layer typically comprises a thermally conductive material to promote the transfer of heat from the heat transfer unit 42 to the sorption member 38, and can be applied to the heat transfer unit 42 as a thin-film coating, for example by a micro gravure coating process or any other suitable process that would be apparent to one of ordinary skill in the art.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A vapour generating system comprising:
a base part including at least one heating element;
a cartridge releasably connectable to the base part, the cartridge comprising:
a liquid store for storing a vapour generating liquid, the liquid store including a liquid outlet;
a vaporization chamber in communication with the liquid outlet for receiving vapour generating liquid from the liquid store;
a heat transfer unit configured to transfer heat from the at least one heating element to the vaporization chamber to vaporize vapour generating liquid in the vaporization chamber;
wherein the heat transfer unit includes a pliable heat transfer surface in contact with the at least one heating element of the base part.

2. The vapour generating system according to claim 1, wherein the pliable heat transfer surface includes a flexible layer applied to the heat transfer unit.

3. The vapour generating system according to claim 2, wherein the flexible layer comprises a thermally conductive material.

4. The vapour generating system according to claim 2, wherein the flexible layer is a coating.

5. The vapour generating system according to claim 1, wherein the heat transfer unit lying substantially in a first plane and a plurality of second portions stepped out of the first plane and lying below the first plane in a second plane substantially parallel with the first plane.

6. The vapour generating system according to claim 5, wherein the heat transfer unit is a substantially circular heat transfer unit, the plurality of first portions are circumferentially spaced around the heat transfer unit, the plurality of second portions are circumferentially spaced around the heat transfer unit, and the plurality of second portions are arranged circumferentially between the plurality of first portions, respectively.

7. The vapour generating system according to claim 6, wherein the plurality of first portions and the plurality of second portions are substantially planar and have corresponding first and second pliable heat transfer surfaces, respectively.

8. The vapour generating system according to claim 7, wherein the at least one heating element comprises a substantially planar heating surface configured to be in contact with the first pliable heat transfer surfaces.

9. The vapour generating system according to claim 7, wherein the at least one heating element comprises a non-planar heating surface configured to be in contact with at least the second pliable heat transfer surfaces.

10. The vapour generating system according to claim 1, further comprising a sorption member at least partially disposed within the vaporization chamber for absorbing vapour generating liquid from the liquid store via the liquid outlet, wherein the heat transfer unit contacts the sorption member to vaporize the absorbed vapour generating liquid

11. A method for manufacturing the vapour generating system according to claim 1, the method comprising:
applying a flexible layer to the heat transfer unit to form the pliable heat transfer surface.

12. The method according to claim 11, wherein the step of applying the flexible layer includes applying a coating to the heat transfer unit.
